(19) United States
(12) Patent Application Publication
(10) Pub. No.: US 2009/0323128 A1
(43) Pub. Date: Dec. 31, 2009

(54) SYSTEM, METHOD, AND COMPUTER PROGRAM PRODUCT FOR SCANNING

(76) Inventors: Hari Asuri, Irvine, CA (US); Armond Mehrabian, Escondido, CA (US)

Correspondence Address: Zilka-Kotab, PC, P.O. BOX 721120, SAN JOSE, CA, 95172-1120, US

(21) Appl. No.: 12/163,822

(22) Filed: Jun. 27, 2008

(51) Int. Cl. H04N 1/00

(52) U.S. Cl. 358/403

(57) ABSTRACT

A system, method, and computer program product are provided for scanning. In use, a plurality of virtual files is stored. Additionally, several of the virtual files are each associated with a particular document type. Further, selection of one of the virtual files is detected. Further still, availability of a scanner is determined. Also, a scan is initiated using the scanner. In addition, scan data is received from the scanner. Further, the scan data is processed according to parameters in the selected virtual file. Further, the scanned images are displayed to the user for repair and acceptance, optionally based on a parameter in the selected virtual file or user request. Further still, a scan file is output to at least one of a user, a memory, and another process. Additional systems, methods and computer program products are also presented.

### FIELD OF THE INVENTION

The present invention relates to scanning, and more particularly to scanning and processing documents and/or other data.

### BACKGROUND

The scanning of documents is widespread and scanned documents are used for a variety of purposes. However, under many circumstances users must manually set up and perform the desired scanning. For example, a user who needs to scan and attach a physical document to an electronic mail message may have to open a scanning application, set one or more parameters of the application, select the output location, scan the document, and then open the target electronic mail message authoring application and select the scanned file from within the application.

In addition to the many steps above, the user may have to check if the scanned images were scanned correctly and if they were not scanned to their level of satisfaction, they may have to rescan the images by repeating the above steps. The number of steps to follow makes the scanning operation tedious.

There is thus a need for addressing these and/or other issues associated with the prior art.

### SUMMARY

A system, method, and computer program product are provided for scanning. In use, a plurality of virtual files is stored. Additionally, several of the virtual files are each associated with a particular document type. Further, selection of one of the virtual files is detected. Further still, availability of a scanner is determined. Also, a scan is initiated using the scanner. In addition, scan data is received from the scanner. Further, the scan data is processed according to parameters in the selected virtual file. Further still, a scan file is output to at least one of a user, a memory, and another process.

A system, method, and computer program product are provided for creating an electronic mail message with an attachment. In use, selection of one of a plurality of virtual files is detected. Additionally, several of the virtual files are associated with particular document types. Further, availability of a scanner is determined. Further still, a scan is initiated using the scanner. Also, scan data is received from the scanner. In addition, the scan data is processed according to parameters in the selected virtual file for generating a scan file. Furthermore, the scan file is automatically attached to an electronic mail message.

A system, method, and computer program product are provided for creating a scan file. In use, selection of one of a plurality of virtual files is detected. Additionally, several of the virtual flies are associated with particular document types. Further, the virtual file is selected from within an application program using an open file feature of the application program. Further still, availability of a scanner is determined. Also, a scan is initiated using the scanner. In addition, scan data is received from die scanner. Further, the scan data is processed according to parameters in the selected virtual file for generating the scan file. Further still, the scan file is output.

A system, method, and computer program product are provided for creating a scan file and adding a hyperlink to the scanned file to an electronic mail message. In use, selection of one of a plurality of virtual files is detected. Additionally, several of the virtual files are associated with particular document types. Further, the virtual file is selected from within an application program using an open file feature of the application program. Further still, availability of a scanner is determined. Also, a scan is initiated using the scanner. In addition, scan data is received from the scanner. Further, the scan data is processed according to parameters in the selected virtual file for generating the scan file. Further, the scan data may be displayed to the user for repair and acceptance, optionally based on a parameter in the selected virtual file or user request. Further still, the scan file is output. Furthermore, a hyperlink, e.g., in a URL or UNC-pathname form, is attached to an electronic mail message.

Other aspects, advantages and embodiments of the present invention will become apparent from the following detailed description, which, when taken in conjunction with the drawings, illustrate by way of example the principles of the invention.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for scanning, in accordance with one embodiment.

FIG. 4 a method for attaching a scanned file to an electronic mail message, in accordance with another embodiment.

FIG. 5 shows a method for creating a scan file, in accordance with yet another embodiment.

FIG. 6 shows a method for creating a scan file and attaching a hyperlink to an electronic mail message in accordance with another embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

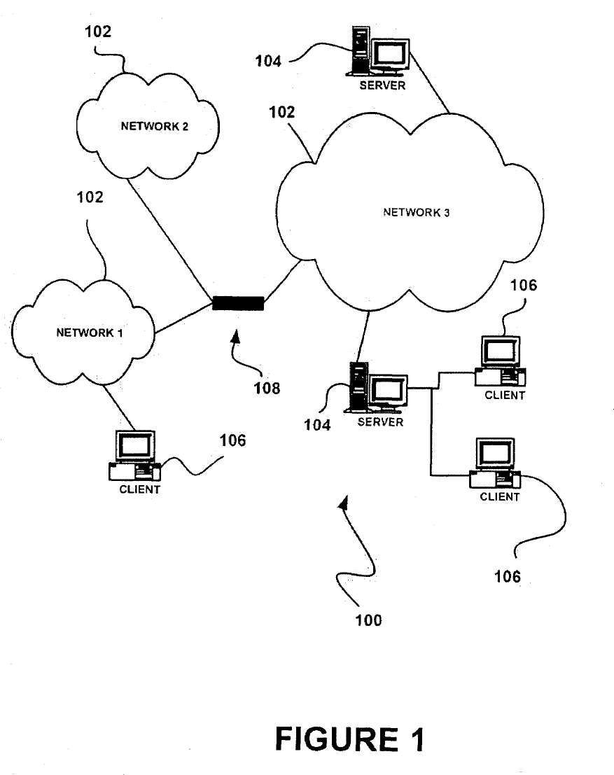

FIG. 1 illustrates a network architecture 100, in accordance with one embodiment. As shown, a plurality of networks 102 is provided, in the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

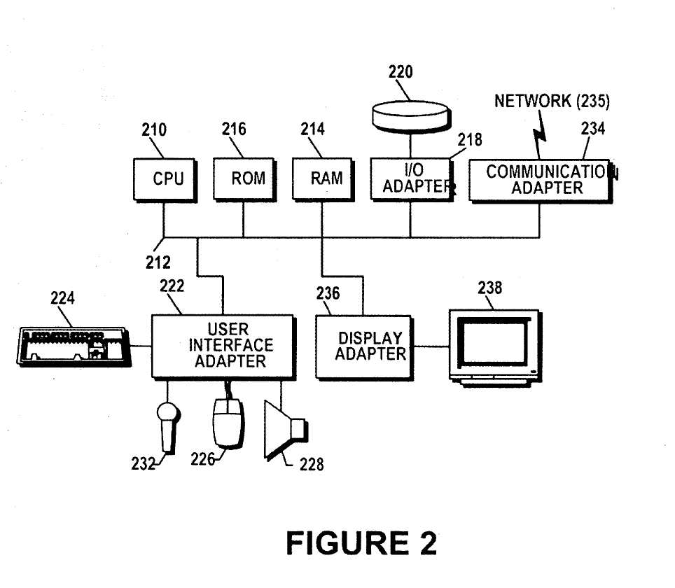

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

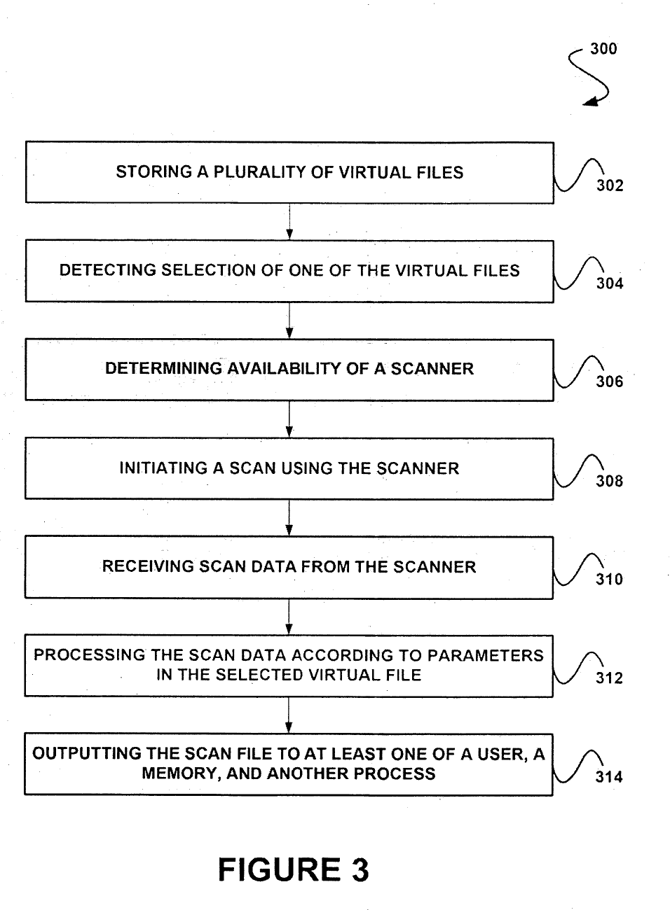

FIG. 3 shows a method 300 for scanning, in accordance with one embodiment. As an option, the method 300 may be carried out in the context of the architecture and environment of FIGS. 1 and/or 2. Of course, however, die method 300 may be carried out in any desired environment.

As shown in operation 302, a plurality of virtual files is stored. Additionally, several of the virtual files are each associated with a particular document type. Further, as shown in operation 304, selection of one of the virtual files is detected. Further still, as shown in operation 306, availability of a scanner is determined. Also, as shown in operation 308, a scan is initiated using the scanner.

In addition, as shown in operation 310, scan data is received from the scanner. Further, as shown in operation 312, the scan data is processed according to parameters in the selected virtual file. Further still, as shown in operation 314, a scan file is output to at least one of a user, a memory, and another process. For example, the scanned images may be displayed to the user for repair and acceptance, optionally based on a parameter in the selected virtual file or user request.

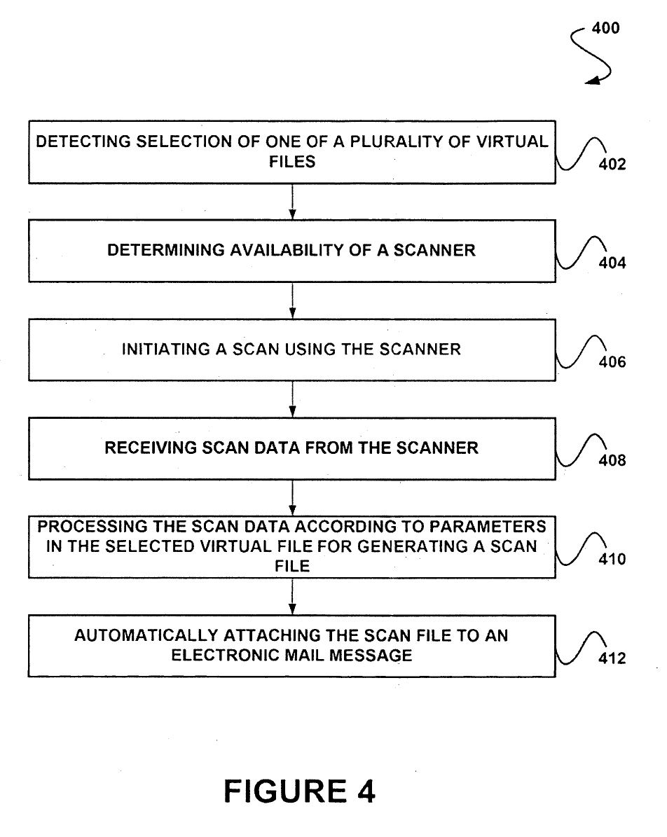

FIG. 4 illustrates a method 400 for creating an electronic mail message with an attachment, in accordance with another embodiment. As an option, the method 400 may be implemented in the context of the architecture and environment of FIGS. 1-3. Of course, however, the method 400 may be implemented in any desired environment. Yet again, it should be noted that the aforementioned definitions may apply during the present description.

As shown in operation 402, selection of one of a plurality of virtual files is detected. Additionally, several of the virtual files are associated with particular document types. Further, as shown in operation 404, availability of a scanner is determined. Further still, as shown in operation 406, a scan is initiated using the scanner.

Also, as shown in operation 408, scan data is received from the scanner. In addition, as shown in operation 410, the scan data is processed according to parameters in the selected virtual file for generating a scan file. The scanned images may be displayed to the user for repair and acceptance, optionally based on a parameter in the selected virtual file or user request. Furthermore, as shown in operation 412, the scan file is automatically attached to an electronic mail message.

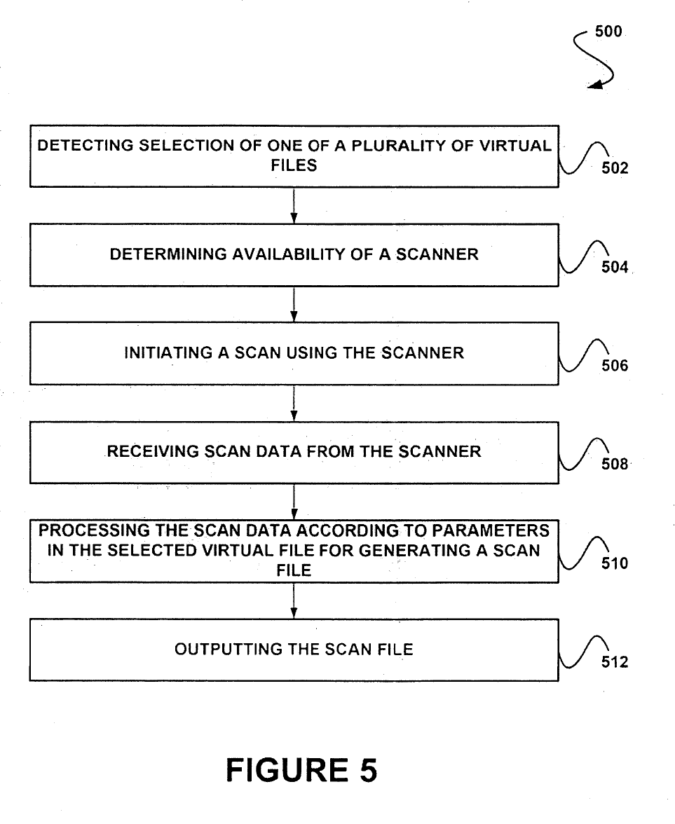

FIG. 5 illustrates a method 500 for creating a scan file, in accordance with yet another embodiment. As an option, the method 500 may be implemented in the context of the architecture and environment of FIGS. 1-4. Of course, however, the method 500 may be implemented in any desired environment. Yet again, it should be noted that the aforementioned definitions may apply during the present description.

As shown in operation 502, selection of one of a plurality of virtual files is detected. Additionally, several of the virtual files are associated with particular document types. Further, the virtual file is selected from within an application program using an open file feature of the application program. Further still, as shown in operation 504, availability of a scanner is determined.

Also, as shown in operation 506, a scan is initiated using the scanner. In addition, as shown in operation 508, scan data is received from the scanner. Further, as shown in operation 510, the scan data is processed according to parameters in the selected virtual file for generating the scan file. Note that the scanned images may be displayed to the user for repair and acceptance, optionally based on a parameter in the selected virtual file or user request. Further still, as shown in operation 512, the scan file is output.

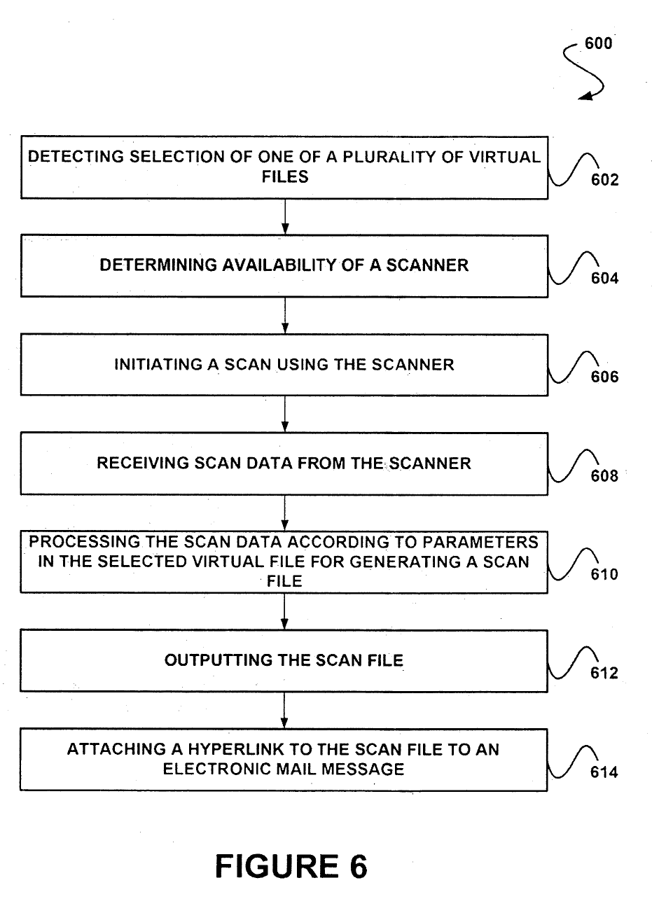

FIG. 6 illustrates a method 600 for creating a scan file and attaching a hyperlink to the scanned file to an electronic mail message, in accordance with yet another embodiment. As an option, the method 600 may be implemented in the context of the architecture and environment of FIGS. 1-5. Of course, however, the method 600 may be implemented in any desired environment. Yet again, it should be noted that the aforementioned definitions may apply during the present description.

As shown in operation 602, selection of one of a plurality of virtual files is detected. Additionally, several of the virtual files are associated with particular document types. Further, the virtual file is selected from within an application program using an open file feature of the application program. Further still, as shown in operation 604, availability of a scanner is determined.

Also, as shown in operation 606, a scan is initiated using the scanner. In addition, as shown in operation 608, scan data is received from the scanner. Further, as shown in operation 610, the scan data is processed according to parameters in the selected virtual file for generating the scan file. Further still, as shown in operation 612, the scan file is output. For example, the scan file may be stored on a local and/or wide area network-accessible site such as a server, website, online database, a user's computer, a computer attached to the scanner, etc. Furthermore, as shown in operation 614, a hyperlink (e.g., in URL or UNC format) to the scan file is attached to an electronic mail message. The recipient of the message may then select the hyperlink to access, retrieve, or view the scan file.

In the context of the present description, the virtual files may include any files that include a structure that can be virtualized. For example, in one embodiment, an underlying structure of the virtual files may be hidden.

Additionally, in one embodiment, the document type may include a black and white or color document. In another embodiment, the document type may include an image document. In still another embodiment, the document type may include an electronic mail message attachment. In yet another embodiment, the document type may include a hyperlink in an electronic mail to a saved document. Of course, however, the document type may include any type of document.

In one embodiment, the several of the virtual files associated with the particular document types may have names reflecting the particular document types. For example, the names may include “photo in color,” “article to archive,” “invoice to email,” etc.

Further, in another embodiment, the plurality of virtual files may be stored in any storage medium. For example, the plurality of virtual files may be stored in one or more disk storage units 220 as illustrated in FIG. 2. In another example, the plurality of virtual files may be stored in one or more servers 104 and/or clients 106 as illustrated in FIG. 1.

Further still, in one embodiment, the selection of the selected virtual file may be detected upon user selection of an icon associated with the virtual file. For example, the selection of the selected virtual file may be detected upon user selection of a desktop icon. In another embodiment, the selection of the selected virtual file may be detected upon the use of the keyboard 224, mouse 226, speaker 228, microphone 232, and/or other user interface devices as illustrated in FIG. 2. Of course, however, the selection of the selected virtual file may be detected in any manner.

Also, in one embodiment, the selection of the one of the virtual files may be performed by a user through an attach file feature of an electronic mail program. In another embodiment, the virtual file may be selected outside of an electronic mail program. In yet another embodiment, the selection of the one of the virtual files is performed by a user through an application program.

Additionally, in one embodiment, the availability of the scanner may be determined by communicating with the scanner. For example, the scanner may be communicated with through the I/O adapter 218, communication adapter 234, and/or bus 212 as illustrated in FIG. 2, etc. In another embodiment, the scanner may be communicated with over the network. In yet another embodiment, the availability of the scanner may include a determination of whether the scanner is currently scanning, online, offline, etc.

Further, in one embodiment, the scanner may include a local scanner. In another embodiment, the scanner may include a network scanner. In yet another embodiment, the scanner may include an integrated scanner.

Also, in one embodiment, the scan may be initiated by sending data to the scanner. For example, the scan may be initiated by sending a scan request to the scanner. Of course, however, the scan may be initiated in any manner.

Further still, in another embodiment, the scan data may include one or more images. In yet another embodiment, the scan data may include a date and time of the scan. In still another embodiment, the scan data may include a source of the scan data, a destination of the scan data category of the scan data, etc.

In another embodiment, the scan data may be received via the network, a local universal serial bus (USB) or parallel port connection, etc. Of course, however, the scan data may be received in any manner.

In addition, in one embodiment, the processing may include performing optical character recognition (OCR) on the scan data, formatting the scan data, encrypting the scan data, compressing the scan data, etc. In another embodiment, the scan file may be saved in a location specified in the virtual file.

In yet another embodiment, the parameters in the selected virtual file may include one or more instructions relating to the processing of the scan data. For example, the parameters in the selected virtual file may include contrast, color setting, page size, type of output file, quality setting, destination for output file, etc.

In still another embodiment, a user may be allowed to adjust the parameters in the selected virtual file. Additionally, in another embodiment, a user may be allowed to create a new virtual file and define at least some of the parameters in the new virtual file.

Further, in another embodiment, outputting the scan data may include displaying the scan data on the display device 238 as illustrated in FIG. 2. In yet another embodiment, outputting the scan data may include attaching all or some of the scan data to an electronic message. For example, the virtual file may be selected from within an email program, and the scan file may be automatically attached to an electronic mail message after generation thereof.

In another embodiment, a composite electronic document comprising die scan file and at least one additional document may be generated. In yet another embodiment, the location of the additional document may be anywhere. In still another embodiment, the scan file may be attached to the electronic mail message as part of the composite document. Also, in another embodiment, determining availability of a scanner, initiating a scan using the scanner, receiving scan data from the scanner, processing the scan data according to parameters in the selected virtual file, and outputting the scan file may be performed without further input from the user except for placing a physical document in the scanner.

In one preferred embodiment, one or more virtual files may be stored on a user's computer. Each virtual file may include a unique scanning profile, which can include user-defined and/or default parameters that define how a document is scanned and how a scanned document is/processed. In another embodiment, when a user wants to scan a document, the user may select a virtual file that includes the desired parameters. For example, the user may open a virtual “scan” folder in the tree structure of an operating system. In another example, the user may select “open” from within an application and select the virtual file.

In still another embodiment, selection of the virtual file may call one or more instances of additional software. For example, software may be called which may automatically detect a scanner attached to the computer. In another example, software may be called which may initiate a scan. In yet another example, software may be called which may receive scan data from the scanner. In still another example, software may be called which may process the scan data according to the parameters of the selected virtual file. In still yet another example, software may be called which may save the resulting scan file in a predefined location on a local computer, a storage location on the network such as on a server inside or outside a LAN, etc.

Virtual Files and Folders

A virtual folder in an operating system may include a folder created and used by a special processing subsystem. In one embodiment, operations on the folder (e.g., selecting, opening, deleting, moving, etc.) may be processed by the special processing system (e.g., instead of normal folder processing operations). In this way, the special processing system may be allowed to operate in a special manner when such operations are performed. The same may apply to virtual files, which may not be designed to be opened and edited by a user, but which may be operated on by the special processing subsystem that knows and understands the contents of such files.

In another embodiment, virtual files may be stored on a user's computer. Each virtual file may contain a unique scanning profile. For example, each virtual file may contain information including scanning parameters (e.g. contrast, color or black/white, page size, type of output file, destination for output file, etc.). In one embodiment, some or all parameters may be defaults. In another embodiment, some or all parameters may be user-defined. In this way, each virtual file may have unique parameters.

In yet another embodiment, the virtual files may be stored in a folder on the user's system. In another embodiment, the virtual files may be named to indicate or reflect the particular parameters stored therein. For example, illustrative file names may include “invoice in black and white,” “photos to email,” “magazine page in color,” etc.

In yet another embodiment, the virtual files may be stored in a folder on the network accessible by the user. In another embodiment, the virtual files may be named to indicate or reflect the particular parameters stored therein. For example, illustrative file names may include “invoice in black and white,” “photos to email,” “magazine page in color,” etc.

### Illustrative Embodiments

In one illustrative example, a user may want to scan a particular document from within an application that can view or attach documents but not scan documents. For example, the user may want to scan the document from within a web based email client. In one embodiment, the user may access the menu system of the application, select “File,” “Open,” browse to the folder having the virtual files, and select one of the virtual files.

In another embodiment, the selection of the virtual file may call backend software which automatically detects a scanner attached to the user's computer. As an option, the backend software may ask the user to select the appropriate scanner if two or more scanners are attached to the user's computer. Additionally, the backend software may initiate a scan of the document without requiring any additional user actions other than feeding the documents to the scanner. Further, the backend software may receive the scan data from the scanner and process the scan data according to the parameters of the selected virtual file.

Further still, the backend software may save the resulting scan file in a predefined location on the computer or a network storage location. The backend software may also navigate to the predefined location so that the user may easily select the scanned file. For example, the resulting image or images may be placed in a temporary folder as well as displayed to the user.

In this way, scanning may be allowed from any application. For example, scanning may be allowed from applications that can view a document that can be stored in one or more formats supported by the scanning subsystem. Therefore, applications that don't support scanning may be able to scan documents. In still another embodiment, from any program that supports opening a document that can be rendered as an image (in the supported image formats), a user can bring up the file browser, open the virtual folder and select one of the scan profiles.

In another illustrative example, assume a user wants to send a scan of a paper document via a web based email client. Using the client, the user may create a new email message and select “attach file.” The user may then select one of the virtual files and click on the “attach” button. This may call software which operates as above to automatically scan and process the document according to the scanning profile stored in the virtual file. The scanned document may then be attached to the message by the user as an attachment. This process may be similar to a user attaching a document that already exists on the user's file system.

In one embodiment, one click scanning may be enabled. For example, a fast scan profile may use the last used profile to scan. In this way, parameters may not need to be set up every time a scan is performed.

In another embodiment, the ability to preview and adjust images may be totally transparent to the application. In yet another embodiment, the ability to build a document (e.g., by scanning some pages, bringing other pages in from other locations on the desktop, including web pages off the Internet) may be enabled before the document is included in the application.

In addition, in still another embodiment, shortcuts may be provided to the virtual files on the user's desktop or any other easily accessible location for quick scanning.

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from die spirit and scope of the present invention. Thus, die present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing either a combination of microprocessors or other specially designed application specific integrated circuits, programmable logic devices, or various combinations thereof. In particular, methods described herein may be implemented by a series of computer-executable instructions residing on a storage medium such as a carrier wave, disk drive, or computer-readable medium. Exemplary forms of carrier waves may be electrical, electromagnetic or optical signals conveying digital data streams along a local network or a publicly accessible network such as the Internet. In addition, although specific embodiments of the invention may employ object-oriented software programming concepts, the invention is not so limited and is easily adapted to employ other forms of directing the operation of a computer.

The invention can also be provided in the form of a computer program product comprising a computer readable medium having computer code thereon. A computer readable medium can include any medium capable of storing computer code thereon for use by a computer, including optical media such as read only and writeable CD and DVD, magnetic memory, semiconductor memory (e.g., FLASH memory and other portable memory cards, etc.), etc. Further, such software can be downloadable or otherwise transferable from one computing device to another via network, wireless link, nonvolatile memory device, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for scanning, comprising:
storing a plurality of virtual files, several of the virtual files each being associated with a particular document type;
detecting selection of one of the virtual files;
determining availability of a scanner;
initiating a scan using the scanner;
receiving scan data from the scanner;
processing the scan data according to parameters in the selected virtual file; and
outputting a scan file to at least one of a user, a memory, and another process.

2. The method of claim 1, wherein the scan file is saved in a location specified in the virtual file.

3. The method of claim 1, wherein the virtual file is selected from within an email program, wherein the scan file is automatically attached to an electronic mail message after generation thereof.

4. The method of claim 1, further comprising displaying scanned images based on the scan data to the user for correction and acceptance.

5. The method of claim 1, wherein a hyperlink to the scan file is automatically attached to an electronic mail message after generation thereof.

6. The method of claim 1, wherein the parameters in the selected virtual file includes contrast, color setting, page size, type of output file, quality setting, and destination for output file.

7. The method of claim 1, wherein the several of the virtual files associated with the particular document types have names reflecting the particular document types.

8. The method of claim 1, further comprising allowing a user to adjust the parameters in the selected virtual file.

9. The method of claim 1, further comprising allowing a user to create a new virtual file and define at least some of the parameters in the new virtual file.

10. The method of claim 1, wherein selection of the selected virtual file is detected upon user selection of a desktop icon.

11. The method of claim 1, further comprising generating a composite electronic document comprising the scan file and at least one additional document from anywhere.

12. The method of claim 1, wherein the following operations are performed without further input from the user except for placing a physical document in the scanner:
determining availability of a scanner;
initiating a scan using die scanner;
receiving scan data from the scanner;
processing the scan data according to parameters in the selected virtual file; and
outputting a scan file.

13. A computer program product comprising a computer readable medium having computer code thereon, which when executed on a computer causes the computer to:
store a plurality of virtual files, several of the virtual files each being associated with a particular document type;
detect selection of one of the virtual files;
determine availability of a scanner;
initiate a scan using the scanner;
receive scan data from the scanner;
process the scan data according to parameters in the selected virtual file for generating a scan file; and
outputting the scan file.

14. A method for creating an electronic mail message with a link to a file, comprising:
detecting selection of one of a plurality of virtual files, several of the virtual files being associated with particular document types;
determining availability of a scanner;
initiating a scan using the scanner;
receiving scan data from the scanner;
processing the scan data according to parameters in the selected virtual file for generating a scan file;
storing the scan file to a predefined location; and
automatically attaching a hyperlink to the scan file to an electronic mail message.

15. The method of claim 14, wherein the selection of the one of the virtual files is performed by a user through an attach file feature of an electronic mail program.

16. The method of claim 14, wherein the virtual file is selected outside of an electronic mail program.

17. The method of claim 14, wherein the selection of the one of the virtual files is performed by a user through an application program.

18. The method of claim 14, wherein the selection of the one of the virtual files is performed by a user selecting a desktop icon.

19. The method of claim 14, wherein the parameters in the selected virtual file includes contrast, color setting, page size, and type of output file.

20. The method of claim 14, wherein the several of the virtual files associated with the particular document types have names reflecting the particular document types.

21. The method of claim 14, further comprising allowing a user to adjust the parameters in the selected virtual file.

22. The method of claim 14, further comprising allowing a user to create a new virtual file and define at least some of the parameters in the new virtual file.

23. The method of claim 14, further comprising generating a composite electronic document comprising the scan file and at least one additional document, the scan file being attached to the electronic mail message as part of the composite document.

24. A method for creating a scan file, comprising:
detecting selection of one of a plurality of virtual files, several of the virtual files being associated with particular document types, wherein the virtual file is selected from within an application program using an open file feature of the application program;
determining availability of a scanner;
initiating a scan using the scanner;
receiving scan data from the scanner;
processing the scan data according to parameters in the selected virtual file for generating a scan file; and
outputting the scan file.

25. The method of claim 24, wherein the parameters in the selected virtual file includes contrast, color setting, page size, type of output file, quality setting, and destination for output file.

26. The method of claim 24, further comprising allowing a user to adjust the parameters in the selected virtual file.

27. The method of claim 24, further comprising generating a composite electronic document comprising the scan file and at least one additional document, the scan, file being attached to the electronic mail message as part of the composite document.
